(19) United States
(12) Patent Application Publication
(10) Pub. No.: US 2013/0291270 A1
(43) Pub. Date: Nov. 7, 2013

(54) Wet suit material with heat-reflective layer

(71) Applicant: Kevin D. Fialko, La Jolla, CA (US)

(72) Inventor: Kevin D. Fialko, La Jolla, CA (US)

(21) Appl. No.: 13/506,664

(22) Filed: May 7, 2012

(51) Int. Cl. B63C 11/04; B32B 15/09; B32B 38/04; B32B 3/10; B32B 7/08; B32B 37/00; B32B 3/26; B32B 3/30

(52) U.S. Cl. 2/2.16; 428/304.4; 428/314.4; 428/316.6; 428/155; 428/138; 428/102; 156/60; 156/256

(57) ABSTRACT

A wet suit material includes a heat-reflective layer in combination with an insulative layer. In some embodiments, the heat-reflective layer is a metalized polymer film slitted to facilitate movement. In other embodiments, multiple panels of heat-reflective layer facilitate movement. In other embodiments, a reflective coating is incorporated in a stretchable liner.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

Embodiments relate to a wet suit material, useful for fabricating articles from for use in underwater diving or water surface activities, and more particularly to wet suit materials incorporating a heat-reflective layer or panels in combination with one or more stretchable insulative layers.

### BACKGROUND OF THE INVENTION

Wet suits are generally used to stay warm in water that is too cold to be comfortable, or to stay warm when evaporative cooling might otherwise extract undue energy from the user. Typical activities where wet suits are used include snorkeling, SCUBA diving, open-water swimming, fishing, surfing, and wind-surfing. Conventional wet suits are insulative, with greater insulation being achieved for thicker sections of a given material (generally, an elastomeric closed-cell foam, such as neoprene). The insulative character of the wet suit conserves energy of the user by reducing energy (body heat) lost to the colder water. A thicker wetsuit generally results in less energy loss. Unfortunately, thicker wet suits are generally more restrictive of movement, and can result in the user having to work against the wet suit. Furthermore, thicker wetsuits provide more floatation, and divers use additional weight on a weight belt to counteract the floatation.

Therefore, wet suit materials that provide superior heat retention for the user while avoiding the disadvantages of the prior art are desirable.

### SUMMARY OF THE INVENTION

In one embodiment, a wet suit material has an elastic insulative foam layer having a first surface configured to be proximal to a user and a second surface configured to be distal from the user and a reflective layer between the user and the second surface of the elastic insulative layer. The elastic insulative layer is, for example, closed-cell rubber foam such as neoprene foam. The reflective layer can be formed on the first surface, such as by painting on a leafing pigment of reflective flakes. Alternatively, the reflective layer is disposed on a stretchable liner that is bonded or otherwise attached to the first surface of the elastic insulative foam layer. In some embodiments, the wetsuit material includes reflective thread stitched through at least the elastic insulative foam layer, and in further embodiments, the reflective thread forms a stitched reflective field on an elastic insulative foam layer.

In another embodiment, the reflective layer is between the elastic insulative foam layer and a second elastic insulative foam layer. In particular embodiments, the reflective layer includes a reflective metal layer, such as an aluminum layer, formed on a polymer film, such as a polyester film. A slit is optionally provided in the reflective layer to allow easier movement and adhesive to bond the elastic insulative foam layer to the second elastic insulative foam layer through the slit. In a further embodiment, a breakable link is provided in the slit. The reflective layer also optionally includes perforations through which the adhesive bonding the elastic insulative foam layer to the second elastic insulative foam layer can extend.

In some embodiments, the reflective layer includes multiple reflective panels that are separated from each other to facilitate movement. For example, in an arm portion of a wet suit, a first reflective panel includes a shoulder end and a first elbow end and a second reflective panel includes a second elbow end and a wrist end.

In another embodiment, a method of fabricating a wet suit material includes forming a reflective interlayer; and laminating the reflective interlayer between a first elastic insulative foam layer and a second elastic insulative foam layer. The reflective interlayer is formed, for example, by depositing a metal layer on a polymer film. A slit or perforations are optionally formed in the reflective interlayer before laminating. In some embodiments reflective interlayer comprises a first reflective panel and a second reflective panel, the first reflective panel and the second reflective panel being laminated between the first elastic insulative foam layer and the second elastic insulative foam layer.

In another embodiment, a wet suit is fabricated by depositing a reflective coating on a first surface of a stretchable fabric. The stretchable fabric is laminated or bonded to an insulative layer to form a wet suit material and a wet suit is fabricated from the wet suit material. In some embodiments, a first portion of the wet suit is fabricated from the wet suit material and a second portion of the wet suit is fabricated from a second wet suit material.

### BRIEF DESCRIPTION OF THE DRAWINGS

FIG. 1 is a view of a wet suit according to an embodiment.

FIG. 2 is a sectional view of a wet suit laminate with a reflective interlayer between insulative layers according to an embodiment.

FIG. 3 is a sectional view of a wet suit laminate with a reflective interlayer between insulative layers according to another embodiment.

FIG. 4 is a sectional view of a wet suit laminate with a reflective layer according to another embodiment.

FIG. 5 is a sectional view of a portion of wet suit laminate illustrating partial slitting according to another embodiment.

FIG. 6 is a plan view of reflective panels for incorporation into an arm portion of a wet suit according to an embodiment.

FIG. 7 is a plan view of a portion of a reflective panel illustrating breakable links according to an embodiment.

FIG. 8 is a flow chart of a method of fabricating an article from wet suit material according to an embodiment.

FIG. 9 is a flow chart of a method of fabricating an article from wet suit material according to another embodiment.

### DETAILED DESCRIPTION OF THE DRAWINGS

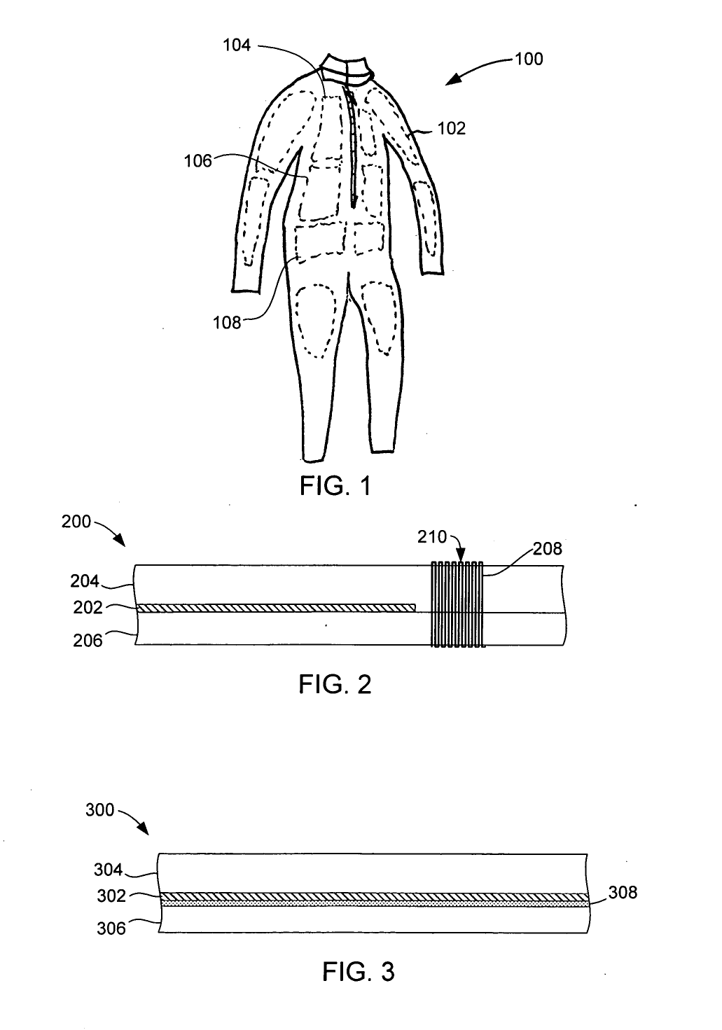

FIG. 1 is a perspective view of a wet suit 100 according to an embodiment. The wet suit 100 is made from wet suit material that incorporates a reflective layer (generally indicated by dashed line 102) between stretchable insulative layers. In a particular embodiment, the stretchable insulative layers are elastomeric closed-cell foam, such as neoprene, butyl rubber, or other foamed polymer. In a particular embodiment, the reflective layer is a polymer web (sheet) with a reflective metal layer deposited on the polymer web. In a more particular embodiment, the reflective layer is a polyester (e.g., MYLAR™) sheet approximately 0.5 mils to approximately 12 mils thick, in some embodiments approximately 1 mil to about 3 mils thick, with a layer of aluminum, silver, gold, or other reflective metal deposited on one or both sides of the polymer sheet. Deposition occurs in a roll coater or similar apparatus, for example.

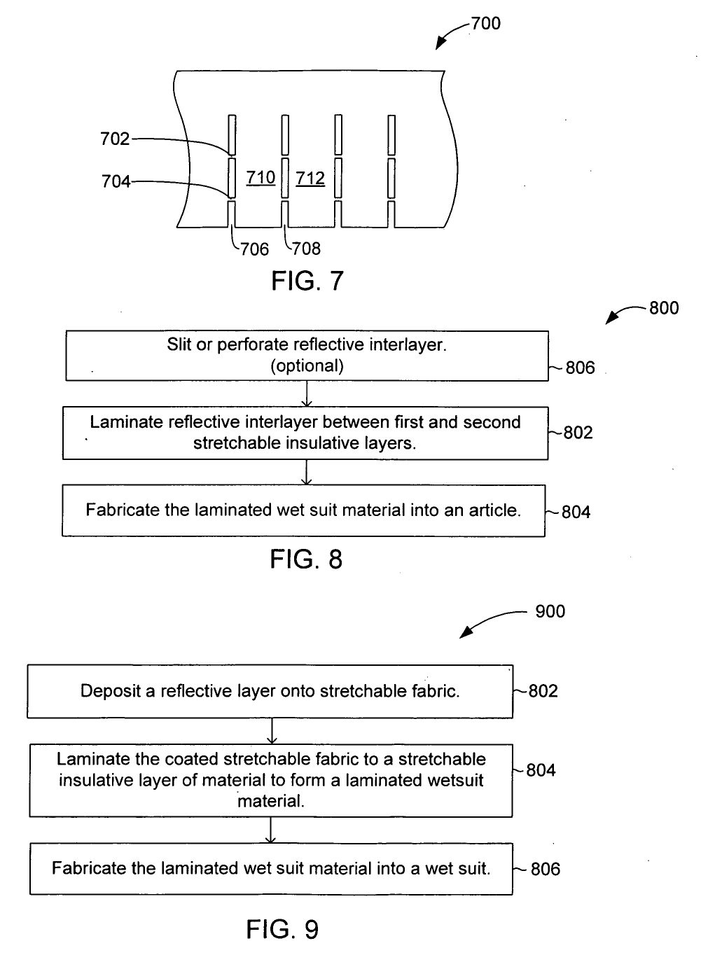

Conventional wet suit materials are typically relatively stretchable to allow a user freedom of movement; however, polyester film has relatively low stretch, and embodiments incorporating low stretch reflective layers typically have one or more features, such as multiple panels 104, 106, 108 or slitting (see, e.g., FIG. 6, ref. num. 608, FIG. 7., ref. nums. 706, 708), to provide a user with sufficient freedom of movement and, in some embodiments, allow an adhesive bonding elastomeric foam layers together to extend through the reflective layer.

Alternative embodiments use a compliant (i.e. stretchable) reflective layer. Examples of complaint reflective layers include knit materials (e.g., nylon or elastane (spandex)) that have had a reflective material (e.g., aluminum, silver, or gold), or elastic webs. In a particular embodiment, an elastic web is a thin (e.g., about 3 mils to about 10 mils) layer of rubber. In an alternative embodiment, a reflective layer is formed on a surface of an insulating layer.

A reflective coating deposited on an elastic web or neoprene foam insulating layer typically has a lower yield point than the web or neoprene foam, so that when a user bends the wet suit where a reflective interlayer or coating is incorporated, the reflective coating cracks. Such cracking is acceptable because it results in relatively little non-reflective area being created, while the reflective coating provides substantial heat reflection back to the user. As used herein, “reflective” generally means that a material, such as a deposited aluminum layer reflects energy in at least the infrared portion of the spectrum.

FIG. 2 is a sectional view of a laminate material 200 suitable for fabricating wet suits or other articles with a reflective interlayer 202 between stretchable insulative layers 204, 206 according to an embodiment. In a particular embodiment the stretchable insulative layers 204, 206 are layers of closed-cell rubber or plastic foam. In a particular embodiment, the reflective interlayer 202 is formed directly on one or both of the insulative layers, which are then laminated together. The reflective interlayer is formed by depositing a reflective material, (e.g. aluminum flakes) such as by spraying or rolling a leafing paint (generally, a paint having metal flakes in a carrier/binder) in which the metal flakes lie essentially flat on the surface of the insulative material as the leafing paint cures, or by using a metal deposition technique to form a thin-film metal layer on a surface of stretchable insulative material. In a particular embodiment, a leafing paint includes a component (e.g., a solvent) suitable for adhering one insulative layer to the other (e.g., the leafing paint also serves as an inter-layer adhesive). In an alternative embodiment, a separate adhesive is used to laminate the insulative layers with an intervening reflective layer. The insulative layers may be approximately the same thickness, or different thicknesses.

In a further or alternative embodiment, reflective thread 208 is used to sew a seam between panels of insulative foam or laminated panels, such as panels including a reflective interlayer, reflective surface layer, or other surface layer. The reflective thread 208 is, for example, aluminized thread, metalized thread, fiber thread wound with a reflectively coated polymer binding, or other thread having greater heat reflectivity than conventional insulative foam.

In a particular embodiment, the reflective thread 208 is stitched to form a stitched reflective field 210. The stitched reflective field 210 is used with or without the reflective interlayer 202. The stitched reflective field 210 is stitched beyond the reflective interlayer 202, or alternatively a reflective field is formed over a portion of a reflective interlayer (not shown).

FIG. 3 is a sectional view of a wet suit laminate 300 with a reflective interlayer 302 between stretchable insulative layers 304, 306 according to another embodiment. The reflective interlayer 302 is a metal thin-film layer, such as an aluminum, silver, or gold thin-film layer, deposited on a web 308. In a particular embodiment, the web 308 is a thin polymer film, such as a polyester film, polyethylene terephthalate film; polypropylene film, including biaxially-oriented polypropylene; or nylon film, including biaxially oriented nylon film. Other web materials are alternatively used. In a particular embodiment, polyester (e.g., MYLAR®) film approximately one mil thick is used as a web material and a thin-film coating of aluminum is deposited on a surface of the film using a roll-coating technique.

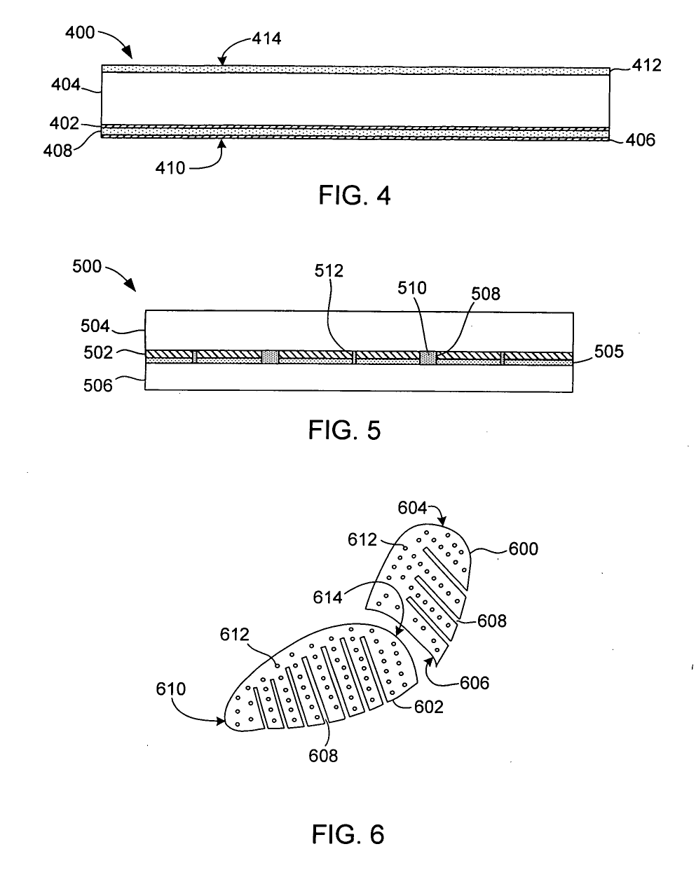

FIG. 4 is a sectional view of a wet suit laminate 400 with a reflective layer 402 according to another embodiment. The wet suit laminate 400 includes an insulative layer 404 of elastic closed-cell foam (e.g., a layer of neoprene foam) with one or more reflective layers 402, 406 on a surface of a stretchable liner 408. In a particular embodiment, the stretchable liner 408 is knit fabric, such as a fabric knit from manufactured fiber in which the fiber forming substance is a long-chain synthetic polyamide (e.g., nylon), elastane (e.g., Lycra®), or blended fiber bonded to the insulative layer 404. Reflective layers 402, 406 are deposited on one or both surfaces of the stretchable liner 408 and the liner is attached to the insulative layer 404. Knit nylon liner layers are often included in conventional wet suits to improve comfort and facilitate getting into and out of the wet suit.

In a particular embodiment, the stretchable liner 408 with reflective layer(s) 402, 406 is on the skin-side 410 of a wet suit (i.e., the side of the wet suit material that is intended (configured) to be proximal to a user). In a further embodiment, a second knit layer is included over portions or essentially the entire exterior surface (i.e., the second surface, which is distal from the user) of the wet suit to improve the abrasion resistance and durability of the wet suit. In a particular embodiment, thin-film aluminum layers are formed (e.g., by physical vapor deposition or other deposition techniques) on one or both sides of a stretchable knit fabric, such as knit nylon, elastane, or blended fabric.

FIG. 5 is a sectional view of a portion of wet suit laminate 500 illustrating partial slitting according to an embodiment. The wet suit laminate 500 includes a reflective interlayer 502, which in a particular embodiment is a thin-film metal layer deposited on a polymer web between stretchable insulative layers 504, 506. The reflective interlayer is slit 508 (see also, FIG. 6, ref. num. 608) to allow movement by a user when a relatively low-stretch material, such as polyester, is used for the polymer web. Adhesive 510 extends through the slit 508 to attach the stretchable insulative layers 504, 506 together. In a further embodiment, holes 512 are formed in the reflective interlayer 502 (see also, FIG. 6, ref. num. 612) to further facilitate adhesion of the insulative layers, which adhesive 510 extending through the holes. Embodiments optionally include adhesive that adheres the insulative layers to the coated or uncoated side(s) of the polymer web.

FIG. 6 is a plan view of reflective panels 600, 602 for incorporation into an arm portion of a wet suit according to an embodiment. In a particular embodiment, a first reflective panel 600 is an upper arm panel and a second reflective panel 602 is a lower arm panel.

The upper arm panel 600 extends essentially from a shoulder end 604 to a first elbow end 606, and the lower arm panel extends essentially from a second elbow end 614 to a wrist end 610. Providing arm panels that are separated at the elbow portion of the wet suit allows a user to freely bend his arm without undue constraint by the reflective panels, which in a particular embodiment are aluminized polyester panels. Similar combinations of panels are used in some embodiments for other areas of a wet suit subject to movement by a user, such as leg portions, shoulder portions, and torso portions.

Slits 608 in the reflective panels 600, 602 further facilitate movement by a user and allow rubber-to-rubber adhesion in embodiments using insulative rubber foam layers. Holes 612 in the reflective panels 600, 602 provide additional rubber-to-rubber adhesion.

FIG. 7 is a plan view of a portion of a reflective panel 700 illustrating breakable links 702, 704 according to an embodiment. In a particular embodiment, the reflective panel 700 is a panel of aluminized polyester, which has relatively low stretch and is slit 706, 708 so as to not unduly restrict movement of a user. The breakable links 702, 704 hold the reflective panel 700 in a desired shape while the wetsuit material is fabricated (e.g., when an aluminized polyester film is laminated between neoprene foam layers). When a user flexes the wetsuit, the relatively low-strength breakable links break, allowing sections 710, 712 of the reflective panel previously held together by the links to move relatively independently from each other.

FIG. 8 is a flow chart of a method of fabricating a wet suit 800 according to an embodiment. A reflective interlayer is laminated between a first elastic insulative foam layer and a second elastic insulative foam layer to form a laminated wet suit material with a reflective interlayer (step 802). In a particular embodiment, the reflective interlayer is aluminized polyester film. In a further embodiment, the reflective interlayer is at least partially slit or perforated prior to lamination (step 806).

In an alternative embodiment, the reflective interlayer is a reflective layer formed on a surface of at least one of the insulative layers. In a particular embodiment, the reflective interlayer is formed from a leafing paint. In an alternative embodiment, the reflective interlayer is deposited, such as by physical vapor deposition, on the surface of the insulative layer.

The laminated wet suit material is fabricated into an article, such as a wet suit (step 804). In a particular embodiment, the wet suit is a one-piece wet suit. In an alternative embodiment, the wet suit includes a jacket and pants or bibs. In yet another embodiment, the article includes pants or bibs, such as are used for waders.

FIG. 9 is a flow chart of a method of fabricating a wet suit 900 according to another embodiment. A reflective coating is deposited on a first surface of a stretchable fabric (step 902). In a particular embodiment, the stretchable fabric is a knit nylon, elastane or a blended fiber. In a particular embodiment, the reflective coating is an aluminum coating. In a more particular embodiment, the reflective coating is applied to the stretchable fabric using a physical vapor deposition technique. In a further embodiment, a second reflective coating is deposited on a second surface of the stretchable fabric.

The first surface of the stretchable fabric is laminated to an insulative layer (904) to form a wet suit material. In a particular embodiment, the insulative layer is a layer of neoprene foam between about 1 mm to about 5 mm thick. An article, such as a wet suit, is fabricated using the wet suit material (906). In a particular embodiment, the wet suit material is used for one or more portions of the wet suit and conventional wet suit material is used for other portions of the wet suit. In another embodiment, wet suit material according to an embodiment is used for first portions of the wet suit, and wet suit material according to another embodiment is used for other portions of the wet suit. For example, some portions of the wet suit are fabricated with a wet suit material according to an embodiment having a first thickness, and other portions of the wet suit are fabricated with a wet suit material according to another embodiment having a second thickness or a second type of reflective layer(s).

In a particular embodiment, the wet suit is a one-piece wet suit. In an alternative embodiment, the wet suit includes a jacket and pants or bibs. In yet another embodiment, the article includes pants or bibs, such as are used for waders; a helmet, booties, or gloves.

While the present invention has been described in connection with specific embodiments, variations of these embodiments will be obvious to those of ordinary skill in the art. For example, alternative insulative materials, combinations of insulative materials, or reflective materials and types of layers could be used, or processing steps could be performed in a different order. Therefore, the spirit and scope of the appended claims should not be limited to the foregoing description.

What is claimed is:

1. A wet suit material comprising:
an elastic insulative foam layer having a first surface configured to be proximal to a user and a second surface configured to be distal from the user; and
a reflective layer between the user and the second surface of the elastic insulative layer.

2. The wet suit material of claim 1 wherein the elastic insulative layer comprises closed-cell rubber foam.

3. The wet suit material of claim 1 wherein the reflective layer is formed on the first surface.

4. The wet suit material of claim 3 wherein the reflective layer comprises reflective flakes.

5. The wet suit material of claim 2 further comprising a stretchable liner disposed on the first surface of the elastic insulative foam layer, wherein the reflective layer is disposed on the stretchable liner.

6. The wetsuit material of claim 1 further comprising reflective thread stitched through at least the elastic insulative foam layer.

7. The wet suit material of claim 6 wherein the reflective thread forms a stitched reflective field on the elastic insulative foam layer.

8. The wet suit material of claim 1 further comprising a second elastic insulative foam layer, the reflective layer being disposed between the elastic insulative foam layer and the second elastic insulative foam layer.

9. The wet suit material of claim 8 wherein the reflective layer includes a reflective metal layer formed on a polymer film.

10. The wet suit material of claim 9 wherein the reflective metal layer is an aluminum layer and wherein the polymer film is a polyester film.

11. The wet suit material of claim 9 further comprising
a slit in the reflective layer; and
adhesive extending through the slit from the elastic insulative foam layer to the second elastic insulative foam layer.

12. The wet suit material of claim 11 further comprising
a breakable link disposed in the slit.

13. The wet suit material of claim 9 further comprising
a perforation through reflective layer, the adhesive extending through the perforation from the elastic insulative foam layer to the second elastic insulative foam layer.

14. The wet suit material of claim 9 further comprising
a perforation in the reflective layer; and
adhesive extending through the perforation from the insulative layer to the second insulative layer.

15. The wet suit material of claim 9 wherein the reflective layer comprises a first reflective panel and a second reflective panel separate from the first reflective panel.

16. A method of fabricating a wet suit material comprising:
forming a reflective interlayer; and
laminating the reflective interlayer between a first elastic insulative foam layer and a second elastic insulative foam layer.

17. The method of claim 16 wherein forming the reflective interlayer comprises depositing a metal layer on a polymer film and, before the laminating step, forming a slit in the reflective interlayer.

18. The method of claim 16 wherein the reflective interlayer comprises a first reflective panel and a second reflective panel, the first reflective panel and the second reflective panel being laminated between the first elastic insulative foam layer and the second elastic insulative foam layer

19. A method of fabricating a wet suit comprising:
depositing a reflective coating on a first surface of a stretchable fabric;
laminating the stretchable fabric to an insulative layer to form a wet suit material; and
fabricating a wet suit including the wet suit material.

20. The method of claim 19 wherein a first portion of the wet suit is fabricated from the wet suit material and a second portion of the wet suit is fabricated from a second wet suit material.
